(19) United States
(12) Patent Application Publication
(10) Pub. No.: US 2016/0009543 A1
(43) Pub. Date: Jan. 14, 2016

(54) Method of Covering at Least Two Seats of a Seating Arrangement

(71) Applicant: rohi stoffe GmbH, Geretsried (DE)

(72) Inventor: Katrin Hielle-Dahm, Munsing (DE)

(21) Appl. No.: 14/599,458

(22) Filed: Jan. 17, 2015

(30) Foreign Application Priority Data
Jan. 22, 2014 (DE) 102014000665.4
Mar. 20, 2014 (EP) 14001020.8

(51) Int. Cl. B68G 7/052; B60N 2/58

(52) U.S. Cl. CPC B68G 7/052; B60N 2/58

(57) ABSTRACT

The invention relates to a method of covering at least two seats of a seating arrangement. The method is characterized by providing a woven length of fabric with at least one stylistic element arranged in a longitudinal pattern repetition, said stylistic element being arranged in the form of at least one local cluster on the length of fabric, cutting several sections to size from the length of fabric and covering at least the seat cushions and backrests of the seats with the cut-to-size sections. The method as per the invention makes an individualization of the visual appearance of a seating arrangement possible, but a uniform overall appearance is preserved. Furthermore, the waste with regard to the length of fabric that is used is reduced in a way that is relevant to costs with the aid of the method as per the invention.

### CROSS-REFERENCE TO RELATED APPLICATIONS

This application claims the benefit under 35 USC 119 of German Application No. DE 102014000665.4 filed on Jan. 22, 2014, and European Application No. EP 14001020.8 filed on Mar. 20, 2014; all applications are incorporated by reference herein in their entirety.

### BACKGROUND

The invention relates to a method of covering at least two seats of a seating arrangement, in particular seats of an aircraft cabin, wherein each seat has at least one seat cushion and one backrest.

Lengths of fabric with very diverse color designs are used in the methods known in the prior art for covering several seats of a seating arrangement. This could involve single-color fabrics or patterned fabrics. In the process, sections are cut to size from the length of fabric and then used to cover the seat cushions, backrests and, if applicable, footrests, headrests and armrests. The length of fabric is structured in such a way that sections cut to size from it will bring about an identical visual appearance of the individual seats and possibly parts of a seat such as seat cushions, backrests etc. The visual appearance is essentially determined by the colors and matching patterns of the cut-to-size sections. The colors are chosen to produce a coherent overall image with the environment, for instance with the side and floor coverings of an aircraft cabin. Now and then, the colors are based on the color scheme of the logo of the passenger transportation service provider, such as an airline for instance. Single-color fabrics or fabrics with a small pattern are used as a preference here to reduce the pattern balancing at the edges or to only get a small amount of waste because of the pattern size.

An endless textile web to create interior linings of motor vehicles and aircraft is known from DE 20 2005 011 116 U1 that has an irregularly patterned, three-dimensional surface raised in relief with a specific repeating pattern length generated via hot embossing over the full surface. When this textile web is used to cover motor-vehicle or aircraft seats, a visually perceptible warping of the textile web does not come about according to this document, so the visual appearance of the covered seats is improved. The appearance of these seats is nearly identical for each seat.

### SUMMARY

The invention relates to a method of covering at least two seats 31, 32, 33 of a seating arrangement, in particular seats 31, 32, 33 of an aircraft cabin, wherein each seat 31, 32, 33 has at least one seat cushion and one backrest.

The method is characterized by providing a woven length of fabric 10, 20, wherein the length of fabric 10, 20 has at least one stylistic element 12, 13, 14, 15, 21, 22, 23, 24, 25, 26, 28, 34, 35, 36, 37, 38, 39, 40, 41, 42, 43, 44, 45, 46, 47 arranged a number of times in a longitudinal pattern repetition on the length of fabric 10, 20, said stylistic element being arranged in the form of at least one local cluster on the length of fabric 10, 20 and the longitudinal pattern repetition having a length of at least 1.20 m,
cutting several sections to size from the length of fabric and
covering at least the seat cushions and backrests of the seats 31, 32, 33 with the cut-to-size sections.

The method as per the invention makes an individualization of the visual appearance of a seating arrangement possible, preferably of an aircraft cabin, but a uniform overall appearance is preserved that can follow the colors of a company logo of a passenger transport company, for instance. Furthermore, the waste with regard to the length of fabric that is used is reduced in a way that is relevant to costs with the aid of the method as per the invention.

### DETAILED DESCRIPTION

The object of the invention is to specify a method of covering at least two seats of a seating arrangement with a length of fabric that makes an individualization of the visual appearance of individual seats or portions of them possible while simultaneously preserving a uniform overall appearance without having to use several lengths of fabric with different designs.

A method is envisaged to solve the problem that is characterized by
providing lengths of woven fabric, wherein the length of fabric has at least one stylistic element positioned multiple times within a longitudinal pattern repetition on the length of fabric that is arranged in the form of at least one local cluster on the length of fabric, and the longitudinal pattern repetition has a length of at least 1.20 m,
cutting several sections to size from the length of fabric and
covering at least the seat cushions and backrests of the seats with the cut-to-size sections.

Further advantageous design forms of the invention follow from the subordinate claims.

What is essential to the method is, on the one hand, the design of the length of fabric that is used and, on the other hand, the use of sections cut to size from the length of fabric, cut from the length of fabric with a substantial reduction of waste, to cover individual parts of the seats, such as seat cushions, backrests, footrests, headrests, armrests and, if necessary, the seat shield. The seat covers known in the prior art that have graphic design elements bring about a level of waste that is relevant with regard to costs because the design elements are always supposed to be positioned in the same place of the seat or parts of it to achieve an identical appearance of the seats or parts thereof. If the length of fabric used for the seat covers has several strips spaced apart from one another and extended over the width of the length of fabric, for example, and if a strip is always supposed to be located in the middle of the seat parts (backrests, armrests etc.), the cut-to-size sections intended to be used to cover the seat parts have to be cut from the length of fabric in such a way that a strip extends through the middle. A substantial amount of waste arises in the process when the strips are spaced far apart on the length of fabric. A level of waste that is relevant with regard to costs also results when there are different dimensions of the seat parts, for instance the seats of various comfort classes of an aircraft cabin (economy class, business class) or the aircraft-cabin seats of different aircraft types. The reduction of waste lowers the costs of producing the seat covers. Waste is understood to mean here that the sections to be cut to size from the length of fabric are not directly next to one another, which leads to the area between the sections not being used and disposed of as garbage.

The method as per the invention makes it possible, in contrast, to individualize a mass-produced article; the mass-produced article of the seats of an aircraft cabin is involved in a preferred example, because the airlines, particularly the large ones, use numerous aircraft types for passenger transport. The use of a length of fabric with the design in accordance with the invention leads to a clearly visible individualization of the individual seats or parts thereof, so the visual appearances of the seats differ from one another. Because of the design of the length of fabric with multiple instances of at least one stylistic element on the length of fabric that is arranged in the form of at least one cluster on the length of fabric. But the uniform overall appearance is ensured with a simultaneous individualization of a seat or parts thereof because of the color scheme of the stylistic elements or the color scheme of the basic color. This aspect of the individualization of individual seats or parts thereof, with a simultaneous preservation of a uniform overall appearance, is the essential aspect of the method as per the invention in addition to a reduction of waste.

A cluster of a stylistic element is understood here to mean that at least three identical stylistic elements exist on a section of the longitudinal pattern repetition in larger numbers than exist on a different, equally large section.

The special advantage of a woven length of fabric of that type is that not all of the cut-to-size sections have to be cut from a fixed, predetermined place on the length of fabric; instead, they can be cut from the length of fabric in such a way that the waste is as small as possible. An individualization of the seats and seat parts automatically takes place in the process because the at least one stylistic element is arranged in the form of at least one local cluster on the length of fabric. The form and/or arrangement and/or color of the stylistic elements can be chosen in such a way that the transition from one longitudinal pattern repetition to another is flowing. That can take place, for example, by having the same stylistic elements from one longitudinal pattern repetition transition into the next one.

The method as per the invention is preferably used to cover seats of an aircraft cabin.

The length of fabric is designed in such a way that the longitudinal pattern repetition will have a length of at least 1.20 m, but preferably a length of 3 m to 10 m. This dimension results from the fact that the seats in the economy class of an aircraft cabin have a seat cushion with a length of at least 45 cm and a backrest with a length of at least 75 cm. At least one seat cushion and one backrest can be covered with sections cut to size from a longitudinal pattern repetition because of that; the individualization effect that is strived for only arises, however, when several seat cushions and backrests have been covered with sections cut to size from a longitudinal pattern repetition. The bigger the longitudinal pattern repetition, the greater the individualization of the individual seats or parts thereof; the length of the longitudinal pattern repetition is limited by the design expenses and the manufacturing expenses, however. A longitudinal pattern repetition of 3 m to 10 m is preferably used to cover aircraft seats, so that the covers of several seat cushions and backrests can be cut from a longitudinal pattern repetition. The individual seats, or their parts as the case may be, do in fact get a uniform overall appearance because of that, but their visual designs are nevertheless individualized due to the heaped arrangement of at least one stylistic element on the length of fabric, because not every section of the longitudinal pattern repetition has to absolutely exist on every seat or a part thereof. The cut-to-size section variants and optimization possibilities are improved by a larger longitudinal pattern repetition here, so an extremely low level of waste is created and the costs of an individual seat cover can therefore be reduced.

In a special variant of the method as per the invention, the stylistic element has a different area density within a cluster in the longitudinal and/or crosswise direction of the length of fabric. A further variation possibility for a visual design exists with the different area density of a stylistic element within a cluster because a cluster within a longitudinal pattern repetition can also extend over larger areas; a stylistic element in one color or in different colors and/or different or equal sizes could be involved.

One or more stylistic elements that could have different or identical colors and/or different or identical sizes can likewise exist within a longitudinal pattern repetition on the length of fabric. It is likewise possible for several stylistic elements that always have the same color to be arranged in a longitudinal pattern repetition. Furthermore, it is possible for several stylistic elements to exist in a longitudinal pattern repetition that always have the same color, but different sizes in each case.

The above-mentioned area density of the stylistic elements arranged on the length of fabric refers to a section of the length of fabric that is 0.1 m to 2 m long, preferably 0.2 m. This means that the area density of a stylistic element is ascertained from the quantity of the stylistic element on a square section of the length of fabric with an edge length of 0.1 m. to 2 m.

In an especially preferred variant of the method as per the invention, the length of fabric has two or more clusters of a stylistic element in the longitudinal and/or crosswise direction within the longitudinal pattern repetition. Because of the arrangement of the at least one stylistic element in the form of several clusters, an individualization of the visual appearance is brought about in an especially obvious way, in particular without the need for the stylistic element to be arranged on the length of fabric in different colors. A viewer will immediately recognize the individual character of the visual appearance of the seats and seat parts in this variant of the length of fabric, even when the stylistic element has the same color scheme.

In a further variant of the method as per the design, there can be provisions for the length of fabric to have two or more clusters of multiple stylistic elements in the longitudinal and/or crosswise direction within the longitudinal pattern repetition. Because of the arrangement of several clusters of two or more stylistic elements, wherein the clusters can have different densities of stylistic elements, an individualization of the visual appearance of a seat and the parts thereof can be sustainably brought about with a simultaneous preservation of a uniform overall appearance. It is up to the designer of the length of fabric here to only consider the individualization of the visual appearance of individual cut-to-size sections to the extent that a uniform overall appearance is preserved.

Moreover, there can also be provisions for at least one stylistic element to only exist in one cluster and/or for at least one stylistic element to be arranged outside of the existing clusters. In the former case, a stylistic element can be arranged a number of times on the length of fabric in the form of a cluster and it will not exist on the length of fabric outside of this cluster. In the latter case, a stylistic element can in fact be arranged a number of times on the length of fabric in the form of a cluster, but it can also be arranged on this length of fabric at a distance from this cluster; the frequency of occurrence of the stylistic element that stands apart from the cluster can decrease, increase or otherwise vary in proportion to the distance from the cluster, for instance.

The at least one stylistic element can be comprised of a line-type or two-dimensional figure that is open or closed, a geometric, amorphous or floral form of a polygonal line or individual, self-contained stylistic elements. The line-type figures can involve circular, star-shaped, rhomboid or flower-type patterns etc. In the simplest case, the line-shaped figures can also involve simple straight lines that extend in a perpendicular fashion, at some different angle or even at a varying angle, from the longitudinal extent of the length of fabric. Two-dimensional figures are understood to mean figures that are comprised of two-dimensional colored areas; the color of the two-dimensional area is different, as was already stated, than the basic color. A polygonal line is understood to mean a line that is comprised of individual straight line segments that are connected to one another. Individual, self-contained stylistic elements are understood to mean stylistic elements that are comprised of straight or curved lines and that have no open ends, for instance circles, squares, rhombuses, flower displays or other geometric figures.

In a further embodiment of the invention, the length of fabric can have a uniform basic color. A uniform overall appearance can be advantageously achieved by the basic color that exists over the entire longitudinal pattern repetition and that exists between several identical or different stylistic elements and/or within stylistic elements. Basic color is understood to mean here the color that fills in the largest surface on the length of fabric and that exists over the entire longitudinal pattern repetition. The basic color can be framed by line-type stylistic elements in connection with this so that the basic color is also within the stylistic elements. In so doing, the stylistic elements can have a color that deviates from the basic color; the basic color will be found here between the multiple stylistic elements and/or within the stylistic elements over the entire longitudinal pattern repetition. Furthermore, the length of fabric can have a color gradient over the entire length of a longitudinal pattern repetition; a uniform overall appearance can then be brought about by the colors of the stylistic elements arranged on the length of fabric, which can be chosen to be identical or to only deviate slightly from one another.

The use of a woven length of fabric with the features that have been described to cover at least two seats of a seating arrangement, especially seats of an aircraft cabin, is likewise the subject matter of the invention notwithstanding further process steps.

Moreover, the subject matter of the invention is an aircraft seat whose parts are covered with a woven length of fabric with the features that have been described.

### BRIEF DESCRIPTION OF THE DRAWINGS

The invention will be explained in more detail below with the aid of the figures. The drawings show the following:

FIG. 1 shows a first embodiment of a longitudinal pattern repetition of a length of fabric to be used to apply the method as per the invention,

FIG. 2 shows a second embodiment of a longitudinal pattern repetition of a length of fabric to be used to apply the method as per the invention,

FIG. 3 shows a third embodiment of a longitudinal pattern repetition of a length of fabric to be used to apply the method as per the invention,

FIG. 4 shows a fourth embodiment of a longitudinal pattern repetition of a length of fabric to be used to apply the method as per the invention, and

FIG. 5 shows a portion of a seating arrangement that is comprised of three seats covered with a length of fabric in accordance with the method as per the invention.

### DETAILED DESCRIPTION OF THE PREFERRED EMBODIMENTS

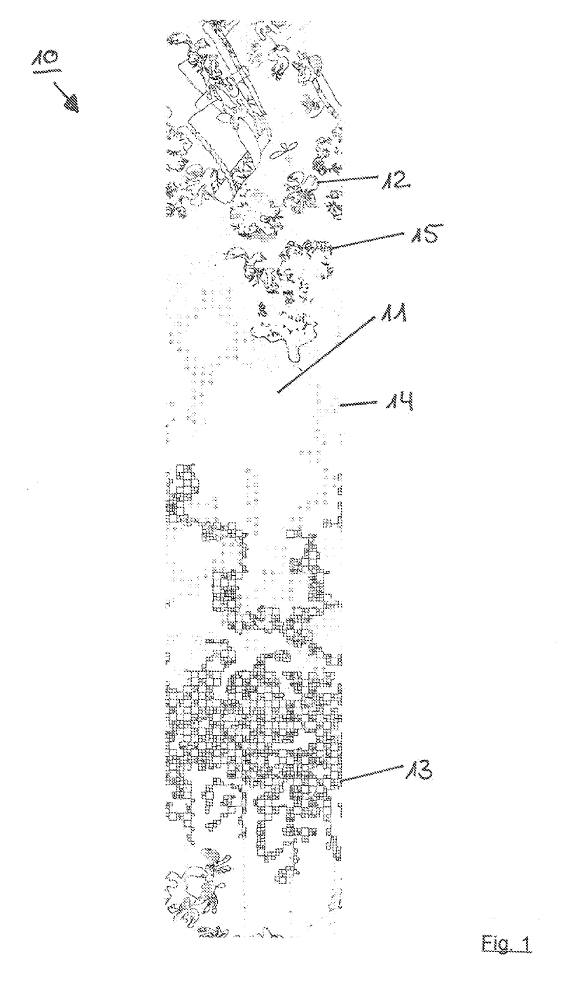

FIG. 1 shows a first embodiment of a longitudinal pattern repetition of a length of fabric 10 to be used to apply the method as per the invention. The length of fabric 10 has a basic color 11 and stylistic elements 12, 13, 14, 15. The stylistic elements 12, 13, 14, 15 are arranged in the form of a local cluster within the longitudinal pattern repetition of the length of fabric 10. The stylistic elements 12 involve line figures that envelop flower patterns 15. The stylistic elements 13 involve line figures in the form of squares of different sizes. The stylistic elements 14 involve two-dimensional figures in the form of circles.

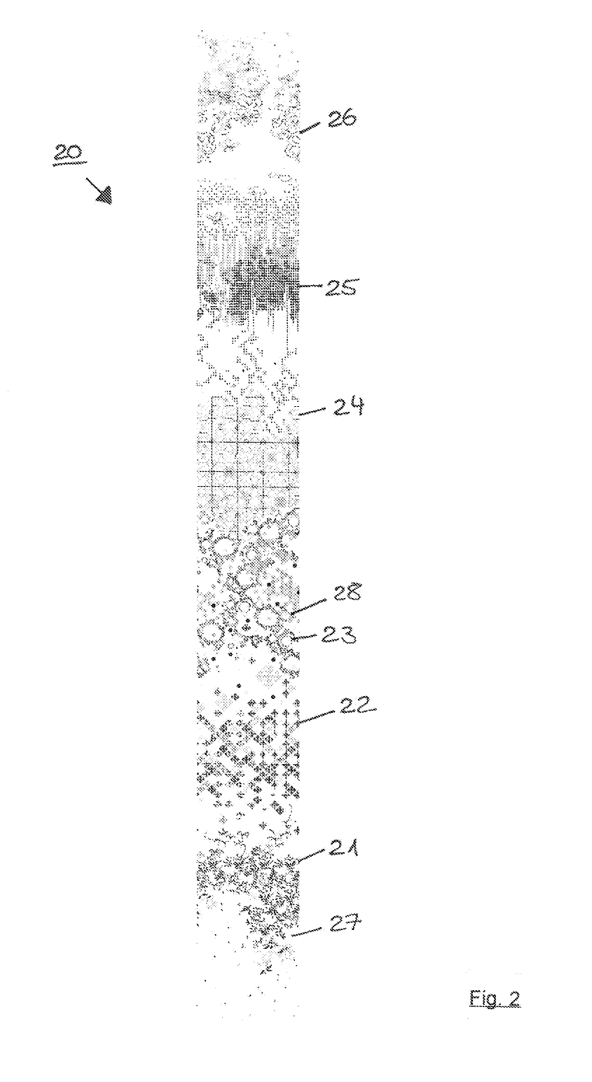

FIG. 2 shows a second embodiment of a longitudinal pattern repetition of a length of fabric 20 to be used to apply the method as per the invention. The length of fabric 20 has a basic color 27 and several different stylistic elements 21, 22, 23, 24, 25, 26, 28. The stylistic elements 21, 22, 23, 24, 25, 26, 28 are arranged in the form of local clusters in a longitudinal pattern repetition of the length of fabric 20. The stylistic elements 21 involve two-dimensional flower figures. The stylistic elements 22 involve square figures that are two-dimensional, but structured and tilted vis-a-vis the direction of extension of the length of fabric 20. The stylistic elements 23 involve two-dimensional circles of a first color differing from the basic color 27. The stylistic elements 28 likewise involve two-dimensional circles of a second color differing from the basic color 27. The stylistic elements 24 involve line-type spider web patterns. The stylistic elements 25 involve, in contrast to the stylistic elements 23 and 28, very small points filled with color. The stylistic elements 26 involve line-type flower figures. All of the stylistic elements 21, 22, 23, 24, 25, 26, 28 are arranged several times on the length of fabric 20 in the form of local clusters.

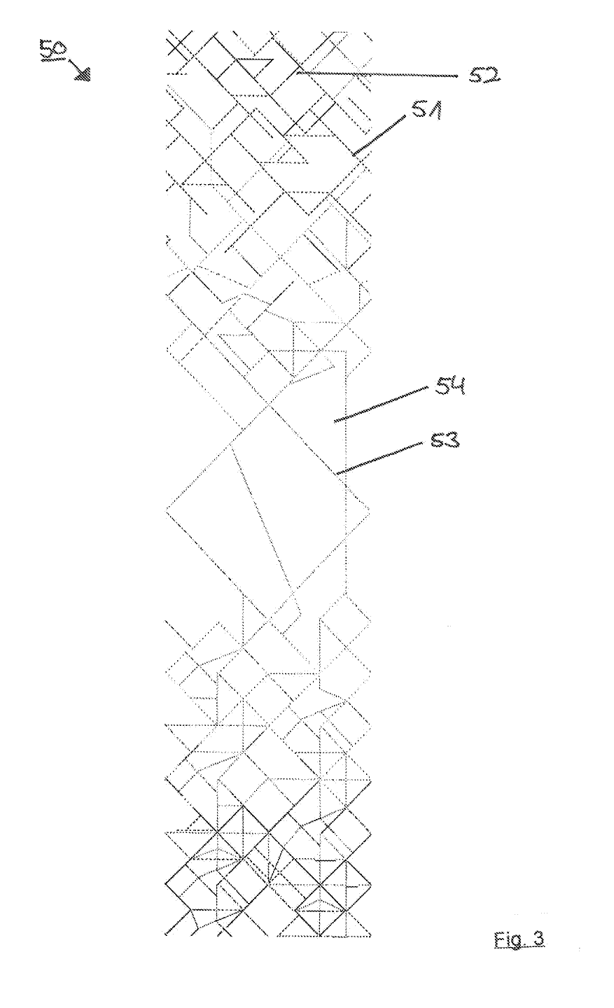

FIG. 3 shows a third embodiment of a length of fabric 50 to be used to apply the method as per the invention. The length of fabric 50 has a basic color 54 and stylistic elements 51, 52, 53; the stylistic element 51 involves a dashed line in a first color, the stylistic element 52 involves a solid line in the first color, and the stylistic element 53 involves a dashed line in a second color. The stylistic elements 51 and 52 are clustered in the proximity of the beginning and end of the longitudinal pattern repetition; in contrast, they are not arranged in the middle of the longitudinal pattern repetition on the length of fabric 50. The stylistic element 53 is likewise clustered in the proximity of the beginning and end of the longitudinal pattern; the clusters of the stylistic element 53 extend beyond the clusters of the stylistic elements 51 and 52 on the longitudinal pattern repetition of the length of fabric 50. The stylistic element 53 is sporadically arranged in the central area of a longitudinal pattern repetition of the length of fabric 50; in contrast, the stylistic elements 51 and 52 are not arranged in the central area of the longitudinal pattern repetition.

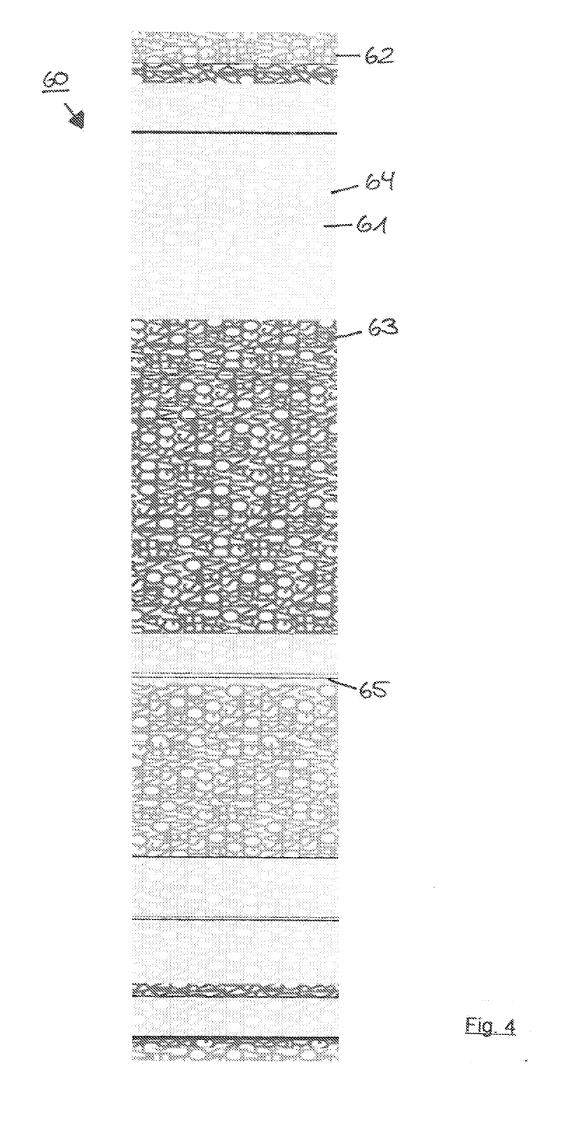

FIG. 4 shows a fourth embodiment of a longitudinal pattern repetition of a length of fabric 60 to be used to apply the method as per the invention. The length of fabric 60 has a basic color 61 and stylistic elements 62, 63, 64, 65. The length of fabric 60 has four clusters in the longitudinal pattern repetition that is shown. The stylistic element 63 has four clusters in the longitudinal pattern repetition, the stylistic element 62 has two clusters in the longitudinal pattern repetition and the stylistic element 65 has several clusters in the longitudinal pattern repetition. The stylistic element 65 involves a straight line that extends in a perpendicular fashion from the direction of extension of the length of fabric, so clusters of the stylistic element 65 have the form of fairly broad strips. The stylistic elements 62, 63, 64 involve letters, wherein the stylistic elements 62, 63, 64 have colors that differ from one another.

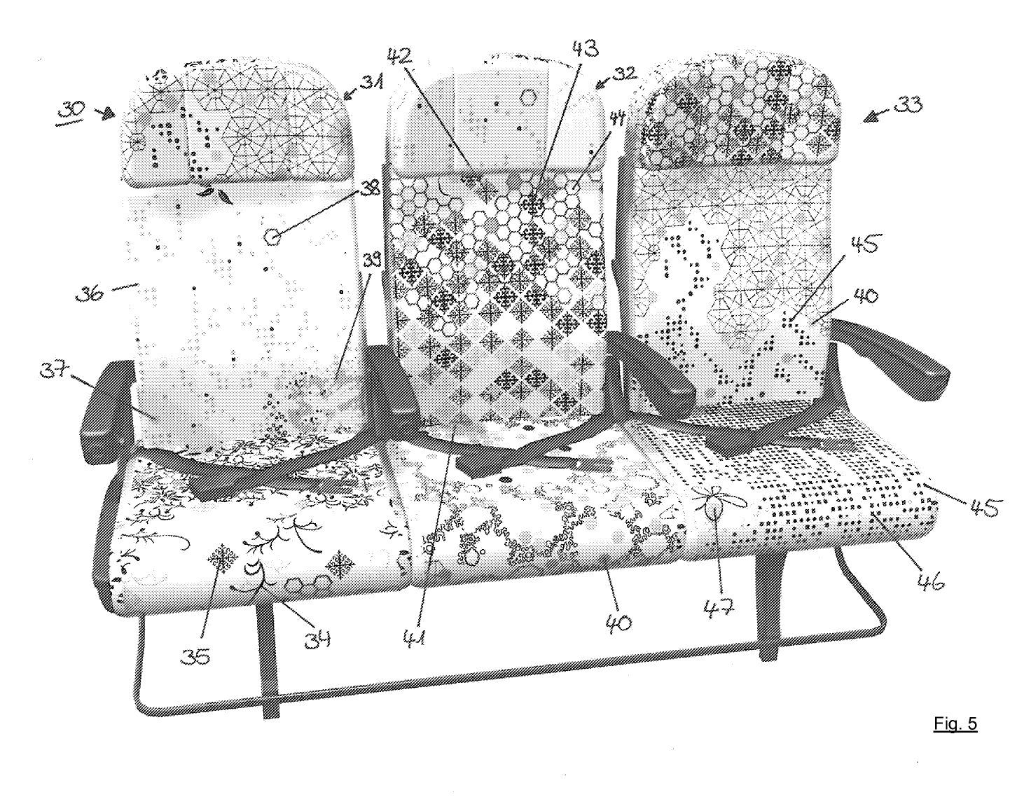

FIG. 5 shows a part 30 of a seating arrangement that is comprised of three seats 31, 32, 33. The seat parts of the seats 31, 32, 33, i.e. the seat cushions and backrests, are covered with a length of fabric in accordance with the method as per the invention. The seat cushions of the seats 31, 32, 33 have a length of approx. 45 cm, and the backrests of the seats 31, 32, 33 have a length of around 75 cm. The seat parts of the seats 31, 32, 33 are covered with cut-to-size sections of the same length of fabric; the length of fabric has a longitudinal pattern repetition of 6 m. Because of the design of the length of fabric with a basic color and several stylistic elements 34, 35, 36, 37, 38, 39, 40, 41, 42, 43, 44, 45, 46, 47 that are arranged a number of times on the length of fabric in the form of local clusters, both the seat cushions and the backrests of the seats 31, 32, 33 have an individualized appearance while the overall impression is simultaneously preserved. Stylistic elements 34 in the form of two-dimensional flower figures are clustered on the seat cushions of the seat 31; in contrast, the stylistic element 35 is only arranged sporadically on the seat cushion in the form of a tilted square. The stylistic element 36 is clustered in the form of small, two-dimensional circles on the backrest of the seat 31; in contrast, the stylistic elements 37 in the form of fairly large, two-dimensional circles, the stylistic elements 38 in the form of hexagons or stylistic elements 39 are only arranged sporadically or at a fairly large distance to one another on the backrest. Stylistic elements 40, 41 are clustered in the form of two-dimensional hexagons on the seat cushion of the seat 32; the stylistic elements 40, 41 differ from one another with regard to their color. Stylistic elements 42, 43 in the form of a tilted square and the stylistic element 44 in the form of hexagons are clustered on the backrest of the seat 32; they are, in contrast, not arranged on the seat surface of the seat 32. Stylistic elements 45 in the form of small, two-dimensional circles and stylistic elements 46 in the form of small, two-dimensional squares are clustered on the seat surface of the seat 33. The stylistic element 47 in the form of a line-type flower figure is, in contrast, only sporadically arranged on the seat surface. Stylistic elements 45 in the form of small, two-dimensional circles are likewise clustered on the backrest of the seat 33; the stylistic elements 46 are not arranged on the backrest of the seat 33, however. On the other hand, stylistic elements 40 in the form of two-dimensional hexagons are sporadically arranged on the backrest.

The dominant basic color provides for a uniform overall impression in this part of the seating arrangement. An individualization of the individual seats and the parts thereof is simultaneously brought about, however, because of the various stylistic elements that are clustered on the parts of the seats 31, 32, 33. The cut-to-size sections can be optimized because of this strived-for individualization, and this leads to a reduction in waste, so a reduction of the production costs of the seat coverings is achieved in addition to an individualization of the seats and parts thereof. The sporadic occurrence of stylistic elements comes about because of the fact that they are also arranged at a distance from clusters. Every stylistic element is arranged in at least one cluster in the longitudinal pattern repetition, however. The length of fabric used to cover the seats 31, 32, 33 in accordance with FIG. 5 has a longitudinal pattern repetition of 6 m; the basic color on the overall longitudinal pattern repetition preserves a uniform overall appearance—with a simultaneous individualization of the seats and their parts via the stylistic elements. This effect can only be achieved in a satisfactory with a length of fabric with a longitudinal pattern repetition of at least 1.20 m, because then every section of the longitudinal pattern repetition does not absolutely have to exist on every seat.

### LIST OF REFERENCE NUMERALS

10 Length of fabric
11 Basic color
12 Stylistic element
13 Stylistic element
14 Stylistic element
15 Stylistic element
20 Length of fabric
21 Stylistic element
22 Stylistic element
23 Stylistic element
24 Stylistic element
25 Stylistic element
26 Stylistic element
27 Basic color
28 Stylistic element
30 Part of a seating arrangement
31 Seat
32 Seat
33 Seat
34 Stylistic element
35 Stylistic element
36 Stylistic element
37 Stylistic element
38 Stylistic element
39 Stylistic element
40 Stylistic element
41 Stylistic element
42 Stylistic element
43 Stylistic element
44 Stylistic element
45 Stylistic element
46 Stylistic element
47 Stylistic element
50 Length of fabric
51 Stylistic element
52 Stylistic element
53 Stylistic element
54 Basic color
60 Length of fabric
61 Basic color
62 Stylistic element
63 Stylistic element
64 Stylistic element
65 Stylistic element

1. Method of covering at least two seats (31, 32, 33) of a seating arrangement, in particular seats (31, 32, 33) of an aircraft cabin, wherein each seat (31, 32, 33) has at least one seat cushion and one backrest,
characterized by
providing a woven length of fabric (10, 20, 50, 60), wherein the length of fabric (10, 20, 50, 60) has at least one stylistic element (12, 13, 14, 15, 21, 22, 23, 24, 25, 26, 28, 34, 35, 36, 37, 38, 39, 40, 41, 42, 43, 44, 45, 46, 47, 51, 52, 53, 62, 63, 64, 65) arranged a number of times in a longitudinal pattern repetition on the length of fabric (10, 20, 50, 60), said stylistic element being arranged in the form of at least one local cluster on the length of fabric (10, 20, 50, 60) and the longitudinal pattern repetition having a length of at least 1.20 m,
cutting several sections to size from the length of fabric (10, 20, 50, 60) and
covering at least the seat cushions and backrests of the seats (31, 32, 33) with the cut-to-size sections.

2. Method according to claim 1,
characterized in that
the longitudinal pattern repetition has a length of 3 m to 10 m.

3. Method according to claim 1,
characterized in that
the stylistic element (12, 13, 14, 15, 21, 22, 23, 24, 25, 26, 28, 34, 35, 36, 37, 38, 39, 40, 41, 42, 43, 44, 45, 46, 47, 51, 52, 53, 62, 63, 64, 65) has different areal densities within a cluster in the longitudinal and/or crosswise direction of the length of fabric (10, 20, 50, 60).

4. Method according to claim 1,
characterized in that
one of the stylistic elements (12, 13, 14, 15, 21, 22, 23, 24, 25, 26, 28, 34, 35, 36, 37, 38, 39, 40, 41, 42, 43, 44, 45, 46, 47, 51, 52, 53, 62, 63, 64, 65) is arranged in different or identical colors and/or sizes within a longitudinal pattern repetition.

5. Method according to claim 1,
characterized in that
several stylistic elements (12, 13, 14, 15, 21, 22, 23, 24, 25, 26, 28, 34, 35, 36, 37, 38, 39, 40, 41, 42, 43, 44, 45, 46, 47, 51, 52, 53, 62, 63, 64, 65) exist that have different or identical colors and/or different or identical sizes.

6. Method according to claim 3,
characterized in that
the areal density refers to a section of the length of fabric (10, 20, 50, 60) with a length of 0.1 m to 2 m, preferably 0.2 m.

7. Method according to claim 1,
characterized in that
the length of fabric (10, 20, 50, 60) has two or more clusters of a stylistic element (12, 13, 14, 15, 21, 22, 23, 24, 25, 26, 28, 34, 35, 36, 37, 38, 39, 40, 41, 42, 43, 44, 45, 46, 47, 51, 52, 53, 62, 63, 64, 65) in the longitudinal and/or crosswise direction in the longitudinal pattern repetition and/or that the length of fabric (10, 20, 50, 60) has two or more clusters of several stylistic elements (12, 13, 14, 15, 21, 22, 23, 24, 25, 26, 28, 34, 35, 36, 37, 38, 39, 40, 41, 42, 43, 44, 45, 46, 47, 51, 52, 53, 62, 63, 64, 65) in the longitudinal and/or crosswise direction in the longitudinal pattern repetition.

8. Method according to claim 1,
characterized in that
at least one element (12, 13, 14, 15, 21, 22, 23, 24, 25, 26, 28, 34, 35, 36, 37, 38, 39, 40, 41, 42, 43, 44, 45, 46, 47, 51, 52, 53, 62, 63, 64, 65) only exists within a cluster and/or that at least one stylistic element (12, 13, 14, 15, 21, 22, 23, 24, 25, 26, 28, 34, 35, 36, 37, 38, 39, 40, 41, 42, 43, 44, 45, 46, 47, 51, 52, 53, 62, 63, 64, 65) is arranged outside of existing clusters.

9. Method according to claim 1,
characterized in that
the at least one stylistic element (12, 13, 14, 15, 21, 22, 23, 24, 25, 26, 28, 34, 35, 36, 37, 38, 39, 40, 41, 42, 43, 44, 45, 46, 47, 51, 52, 53, 62, 63, 64, 65) is comprised of a line-type or two-dimensional figure that is open or closed, a geometric, amorphous or floral form, a polygonal line or individual, self-contained stylistic elements (12, 13, 14, 15, 21, 22, 23, 24, 25, 26, 28, 34, 35, 36, 37, 38, 39, 40, 41, 42, 43, 44, 45, 46, 47, 51, 52, 53, 62, 63, 64, 65).

10. Method according to claim 1,
characterized in that
the length of fabric (10, 20, 50, 60) has a uniform basic color (11, 27, 54, 61) or that the length of fabric (10, 20, 50, 60) has a color gradient over the entire length of a longitudinal pattern repetition.

11. Method according to claim 1,
characterized in that the stylistic elements (12, 13, 14, 15, 21, 22, 23, 24, 25, 26, 28, 34, 35, 36, 37, 38, 39, 40, 41, 42, 43, 44, 45, 46, 47, 51, 52, 53, 62, 63, 64, 65) have a color deviating from the basic color (11, 27, 54, 61), wherein the basic color (11, 27, 54, 61) exists between the stylistic elements (12, 13, 14, 15, 21, 22, 23, 24, 25, 26, 28, 34, 35, 36, 37, 38, 39, 40, 41, 42, 43, 44, 45, 46, 47, 51, 52, 53, 62, 63, 64, 65) with multiple arrangements over the entire longitudinal pattern repetition and/or within the stylistic elements (12, 13, 14, 15, 21, 22, 23, 24, 25, 26, 28, 34, 35, 36, 37, 38, 39, 40, 41, 42, 43, 44, 45, 46, 47, 51, 52, 53, 62, 63, 64, 65).

12. Use of a woven length of fabric (10, 20, 50, 60) for covering at least two seats (31, 32, 33) of a seating arrangement, in particular seats (31, 32, 33) of an aircraft cabin, wherein each seat (31, 32, 33) has at least one seat cushion and one backrest,
characterized in that
the length of fabric (10, 20, 50, 60) has a longitudinal pattern repetition with a length of at least 1.20 m, wherein the length of fabric (10, 20, 50, 60) has at least one stylistic element (12, 13, 14, 15, 21, 22, 23, 24, 25, 26, 28, 34, 35, 36, 37, 38, 39, 40, 41, 42, 43, 44, 45, 46, 47, 51, 52, 53, 62, 63, 64, 65) arranged a number of times within one longitudinal pattern repetition on the length of fabric (10, 20, 50, 60), said stylistic element being arranged in the form of at least one local cluster on the length of fabric (10, 20, 50, 60).

13. Use according to claim 12,
characterized in that
the stylistic element (12, 13, 14, 15, 21, 22, 23, 24, 25, 26, 28, 34, 35, 36, 37, 38, 39, 40, 41, 42, 43, 44, 45, 46, 47, 51, 52, 53, 62, 63, 64, 65) has different areal densities within a cluster in the longitudinal and/or crosswise direction of the length of fabric (10, 20, 50, 60) and/or that the stylistic element (12, 13, 14, 15, 21, 22, 23, 24, 25, 26, 28, 34, 35, 36, 37, 38, 39, 40, 41, 42, 43, 44, 45, 46, 47, 51, 52, 53, 62, 63, 64, 65) exists in different or identical colors and/or is arranged within a longitudinal pattern repetition and/or that several stylistic elements (12, 13, 14, 15, 21, 22, 23, 24, 25, 26, 28, 34, 35, 36, 37, 38, 39, 40, 41, 42, 43, 44, 45, 46, 47, 51, 52, 53, 62, 63, 64, 65) exist that have different or identical colors and/or different or identical sizes.

14. Use according to claim 12,
characterized in that
the length of fabric (10, 20, 50, 60) has two or more clusters of a stylistic element (12, 13, 14, 15, 21, 22, 23, 24, 25, 26, 28, 34, 35, 36, 37, 38, 39, 40, 41, 42, 43, 44, 45, 46, 47, 51, 52, 53, 62, 63, 64, 65) in the longitudinal and/or crosswise direction in the longitudinal pattern repetition and/or that the length of fabric (10, 20, 50, 60) has two or more clusters of several stylistic elements (12, 13, 14, 15, 21, 22, 23, 24, 25, 26, 28, 34, 35, 36, 37, 38, 39, 40, 41, 42, 43, 44, 45, 46, 47, 51, 52, 53, 62, 63, 64, 65) in the longitudinal and/or crosswise direction in the longitudinal pattern repetition.

15. Use according to claim 12,
characterized in that
the stylistic element (12, 13, 14, 15, 21, 22, 23, 24, 25, 26, 28, 34, 35, 36, 37, 38, 39, 40, 41, 42, 43, 44, 45, 46, 47, 51, 52, 53, 62, 63, 64, 65) is comprised of a line-type or two-dimensional figure that is open or closed, a geometric, amorphous or floral form, a polygonal line or individual, self-contained stylistic elements (12, 13, 14, 15, 21, 22, 23, 24, 25, 26, 28, 34, 35, 36, 37, 38, 39, 40, 41, 42, 43, 44, 45, 46, 47, 51, 52, 53, 62, 63, 64, 65).

16. Use according to claim 12,
characterized in that
the length of fabric (10, 20, 50, 60) has a uniform basic color (11, 27, 54, 61) or that the length of fabric (10, 20, 50, 60) has a color gradient over the entire length of the longitudinal pattern repetition and/or that the stylistic elements (12, 13, 14, 15, 21, 22, 23, 24, 25, 26, 28, 34, 35, 36, 37, 38, 39, 40, 41, 42, 43, 44, 45, 46, 47, 51, 52, 53, 62, 63, 64, 65) have a color deviating from the basic color (11, 27, 54, 61), wherein the basic color (11, 27, 54, 61) exists between the stylistic elements (12, 13, 14, 15, 21, 22, 23, 24, 25, 26, 28, 34, 35, 36, 37, 38, 39, 40, 41, 42, 43, 44, 45, 46, 47, 51, 52, 53, 62, 63, 64, 65) arranged a number of times over the entire longitudinal pattern repetition and/or within the stylistic elements (12, 13, 14, 15, 21, 22, 23, 24, 25, 26, 28, 34, 35, 36, 37, 38, 39, 40, 41, 42, 43, 44, 45, 46, 47, 51, 52, 53, 62, 63, 64, 65).

17. Use according to claim 14,
characterized in that
the seat parts according to at least one of the claims 1 to 16 are covered with a woven length of fabric (10, 20, 50, 60).
